(19) United States
(12) Patent Application Publication
(10) Pub. No.: US 2020/0341556 A1
(43) Pub. Date: Oct. 29, 2020

(54) PATTERN EMBEDDABLE RECOGNITION ENGINE AND METHOD

(71) Applicant: Gesto, Inc., San Jose, CA (US)

(72) Inventors: Erick A. Rivera J., Hidalgo (MX); Francisco Martinez, Mexico City (MX)

(73) Assignee: Gesto, Inc., San Jose, CA (US)

(21) Appl. No.: 16/860,061

(22) Filed: Apr. 27, 2020

Related U.S. Application Data
(60) Provisional application No. 62/839,601, filed on Apr. 26, 2019.

(51) Int. Cl. G06F 3/01; G06N 3/04; G01P 15/14

(52) U.S. Cl. CPC G06F 3/017; G06F 3/011; G01P 15/14; G06N 3/04

(57) ABSTRACT

Techniques for obtaining a minimal gesture index are disclosed. In an embodiment, the minimal gesture index is embedded in a wearable device. In an embodiment, the wearable device is a reality augmenting centered field of view wearable device that is part of a reality augmenting visual content presentation management system.

### CROSS-REFERENCE TO RELATED APPLICATIONS

The present application claims priority to U.S. Provisional Patent Application Ser. No. 62/839,601 filed Apr. 26, 2019 and entitled “Gesture Recognition,” which is incorporated by reference herein.

### BACKGROUND

Activity trackers, such as step counters, are known. Also, some wearable devices, such as an Apple watch, can turn a screen on or off in accordance with sensor data, such as an accelerometer. This can be characterized in some cases to be “gesture recognition.” Gesture recognition is typically made possible via sensors, such as a gyroscope, accelerometer, camera, or the like. However, gesture recognition is the subject of ongoing research and development to improve accuracy, such as by improving the ability to differentiate between gestures and non-gesture bodily movement.

### SUMMARY

A neural network learns to differentiate between instructions in the form of gestures and noise. Here, noise is intended to mean movement that is not a gesture intended to be an instruction. Whole gestures are evaluated to provide a command, such as turning a hand from vertical toward horizontal to control a volume setting, twisting a wrist twice to activate (e.g., take a picture, change tracks, dismiss an incoming call), or sweeping a hand to change slides. A gesture recognition algorithm can be packaged and sold to device manufacturers, retailers, or other relevant parties. Gestures can be used to control smartphones, drones, toys, and other physical devices. A control channel between a gesture-detecting device, such as a smartphone, smart band, or other wearable, can be implemented with a standard (e.g., Bluetooth) or proprietary communication protocol. A variety of sensors can be used for training data (e.g., video), and knowledge of the environment can improve gesture recognition and application (e.g., pointing at a light can cause the light to switch on or off if the control device or an agent operating on its behalf knows the location of the light). Knowledge of the environment can be accomplished with cameras, beacons, acoustics, or the like.

### BRIEF DESCRIPTION OF THE DRAWINGS

FIG. 1 depicts a diagram of an example of a system for human-to-machine integration.

FIG. 2 depicts a flowchart of an example of a method for controlling a device using gestures.

FIG. 3 depicts a diagram of an example of a gesture-infused raw data capture and analysis system.

FIG. 4 depicts a flowchart of an example of a method for obtaining a minimal gesture index.

FIG. 5 depicts a diagram of an example of a selective operation mode management system.

FIG. 6 depicts a diagram of an example of a reality augmenting visual content presentation management system.

### DETAILED DESCRIPTION

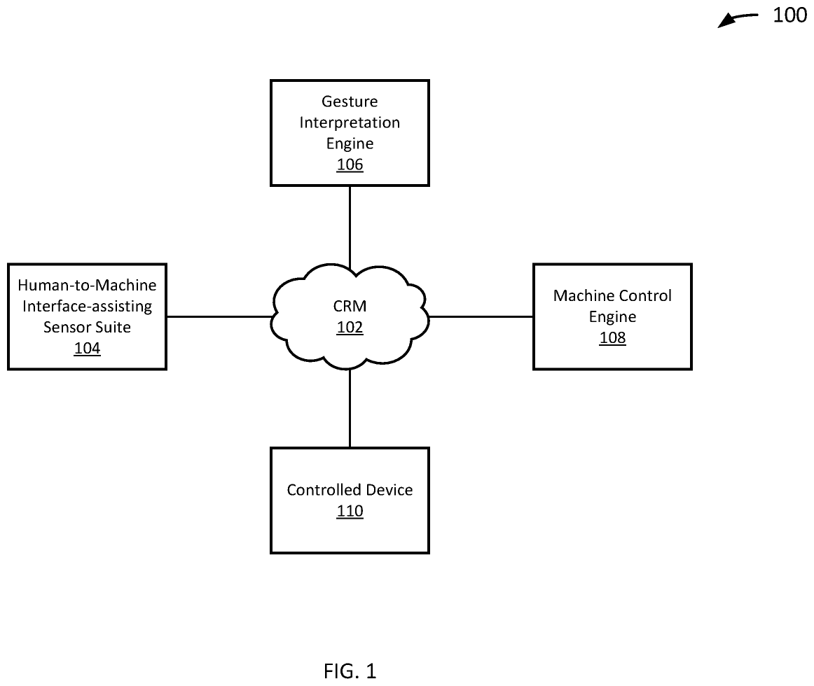

FIG. 1 depicts a diagram 100 of an example of a system for human-to-machine integration. The system of the example of FIG. 1 includes a computer-readable medium 102, a human-to-machine interface-assisting sensor suite 104, a gesture interpretation engine 106, a machine control engine 108, and a controlled device 110.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine includes hardware. The engine may or may not also include firmware or software embodied in a computer-readable medium for execution by a processor of the engine. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the human-to-machine interface-assisting sensor suite 104 is intended to represent one or more devices that detect actions of a human agent in a field of detection. Here, the human agent is intended to represent a human whose actions are interpreted as commands. Here, field of detection may include a field of view for cameras, but also include worn or carried sensors, such as accelerometers and gyroscopes for use in determining an orientation and movement, which can detect movement of the device in which they are housed or otherwise affixed (and the detected stimuli are considered within the field of detection). Sensor data processors or preprocessors, power sources, wireless or physical interfaces, and the like can be considered part of the human-to-machine interface-assisting sensor suite 104, or as separate components, depending upon context. For example, a depth-sensing camera included as part of the human-to-machine interface-assisting sensor suite 104 can perform pre-processing on a feed it generates in order to further facilitate manipulation, e.g. object detection, of the feed, then transmit the data via radio. As an example of a wireless or physical interface, the human-to-machine interface-assisting sensor suite 104 can include a network interface, such as a wireless interface configured to transmit and receive data over a wireless connection established and maintained in accordance with a Wi-Fi protocol or an applicable cellular protocol.

In a specific implementation, the human-to-machine interface-assisting sensor suite 104 includes a sensor for determining involuntary actions of a human agent. For example, the human-to-machine interface-assisting sensor suite 104 can include an inward facing camera that captures facial expressions of the human agent. (Of course, an inward facing camera could also detect voluntary actions.) In another example, the human-to-machine interface-assisting sensor suite 104 can include a pulsemeter, heart monitor, blood pressure sensor, or other sensor that measures bodily functions. Depending upon implementation-specific, configuration-specific, or other factors, unintended actions, such as an expression of fear, increased pulse, falling down, or the like can be interpreted as commands appropriate in an emergency context (e.g., to dial an assistance provider), an exercise context, or the like. It may be desirable to have a gesture that serves to “wave off” commands generated via unintended actions (e.g., to indicate the human agent is fine after falling down).

In a specific implementation, at least a portion of the human-to-machine interface-assisting sensor suite 104 is a component of a handheld device, such as a smartphone. In an alternative implementation, at least a portion of the human-to-machine interface-assisting sensor suite 104 is a component of a wearable device. For example, the human-to-machine interface-assisting sensor suite 104 can be of a shape and design to be worn on the wrist of a human agent (e.g., a smart band), on the body of a human agent (e.g., smart clothes), or on the head of a human agent at a position where reality augmenting visual content can be presented to the human agent (e.g., goggles).

In a specific implementation, the human-to-machine interface-assisting sensor suite 104 is coupled to a display for presenting content to the human agent; the content may include data associated with devices being controlled via the human-to-machine interface. In an augmented reality implementation, a display is segmented to present different portions of reality augmenting visual content as part of displaying reality augmenting visual content. The display can include an edge region configured to present reality augmenting visual content along the edges of the display and a central region configured to present images centered in a field of view of a user. For example, the display can include edge LEDs configured to display a stream of vital signs of the human agent while a central region can display documents to the human agent.

Reality augmenting visual content includes images (including video, if applicable). For example, reality augmenting visual content can include images provided to a surgeon (and, ideally, the surgeon can control instrumentation with gestures even if the surgeon's hands are being used). In another example, reality augmenting visual content can include virtual documents an engineer can read during a manufacturing process (and, ideally, the engineer can control instrumentation with gestures even if the engineer's hands are being used). Additionally, reality augmenting visual content can include a captured real-world field of view of a user that can potentially be modified. For example, reality augmenting visual content can include a feed of a captured real-world field of view of a user with images superimposed onto the real-world field of view. In another example, reality augmenting visual content can include a feed of a captured real-world field of view of a user with objects removed from the real-world field of view. It may be noted a virtual reality variant simply replaces human perception of a surrounding environment with the virtual reality variant, but the human agent can gesture in a similar manner to impact the virtual reality or, to the extent the virtual reality is an overlay of an existing reality, control devices that are in tune with the virtual reality so as to impact the real world. For example, a remote surgeon could operate on an actual patient using virtual reality visual content to control real-world instrumentation. Reality augmenting audio content is also possible.

In a specific implementation, the human-to-machine interface-assisting sensor suite 104 includes sensors for capturing a real-world environment for the human agent. For example, the human-to-machine interface-assisting sensor suite 104 can include an outwardly facing camera or a microphone; moreover, if the human-to-machine interface-assisting sensor suite 104 captures sufficient stimuli to identify a real-world object, information could be provided to the human agent about the object. As another example, the human-to-machine interface-assisting sensor suite 104 can include a global positioning system (“GPS”) receiver; a determined position of the human-to-machine interface-assisting sensor suite 104 using GPS can be used to determine appropriate local resources, determine points of interest, remain in contact with the human agent (e.g., if the human agent is a child playing with a remote-controlled toy and a parent wants to send a message to the child or know the child's location), or the like, and provide directions to, advertisements for, or other data associated with the surrounding environment. As another example, the human-to-machine interface-assisting sensor suite 104 can include one or more near-field communication (NFC) sensors and relevant components that function to enable NFC communication with an applicable electronic device.

In a specific implementation, the human-to-machine interface-assisting sensor suite 104 is configured to operate in different power consumption modes. For example, the human-to-machine interface-assisting sensor suite 104 can operate in a low power mode in which it consumes less power than it would in operating in a normal operation mode. For example, a camera for capturing a real-world field of view of a human agent can be selectively powered on and off to vary power consumption levels. As another example, if a human agent has not gestured for a span of time, then it can be determined to operate the human-to-machine interface-assisting sensor suite 104 in a low power mode.

The gesture interpretation engine 106 is intended to represent an engine that converts applicable stimuli in the field of detection of the human agent into commands. In a specific implementation, the human-to-machine interface-assisting sensor suite 104 and the gesture interpretation engine 106 are implemented on separate devices, though some aspects of gesture interpretation (e.g., pre-processing of detected stimuli) can occur on the human-to-machine interface-assisting sensor suite 104 before being transmitted to the gesture interpretation engine 106. In an alternative, one or more of the components of the gesture interpretation engine 106 and one or more of the components of the human-to-machine interface-assisting sensor suite 104 are implemented on the same device.

The machine control engine 108 is intended to represent an engine that transmits commands from the gesture interpretation engine 106 to the controlled device 110. In a specific implementation, the machine control engine 108 includes a wireless interface through which the commands are transmitted to the controlled device 110. In an alternative, the machine control engine 108 includes a wired interface.

The controlled device 110 is intended to represent a device that changes its behavior in response to commands received from the machine control engine 108. In a specific implementation, the controlled device 110 includes an actuator that acts to change location, orientation, or posture of at least one component of the controlled device 110. In an alternative, the controlled device 110 is a computer that receives the commands and changes characteristics of objects within a virtual environment.

The system described above with reference to FIG. 1 can be used to control robots, e.g., by holding a hand out and moving the hand up and down to move a drone, bending the wrist in to call the drone, and bending the wrist out to send the drone away. The components can also be used for tracking purposes. For example, a parent could track a child playing with a toy (including communicating with the child about a time to come home, a time to take medication, or other reminders) while the child uses gestures to control the toy. Knowledge of an environment can enable overloading of gestures to suit the relevant environment. For example, a surgeon or mechanic with hands busy can control instrumentation specific to their tasks; gestures can be interpreted to turn on lights, adjust temperature, etc. when a person has just entered a room, but other interpretations take precedence after the person has an established presence.

Advantageously, the system is accurate enough to distinguish commands from random movement with an accuracy that makes it useful in environments that demand extreme precision. For example, the techniques described in this paper support “sign in the air” technology that can be used for authentication, to make payments, or to sign a legally binding document if such a thing is supported by law. Using the training techniques described below, it is also possible to recognize turbine movement to determine if a turbine will fail or otherwise training on raw data to identify patterns.

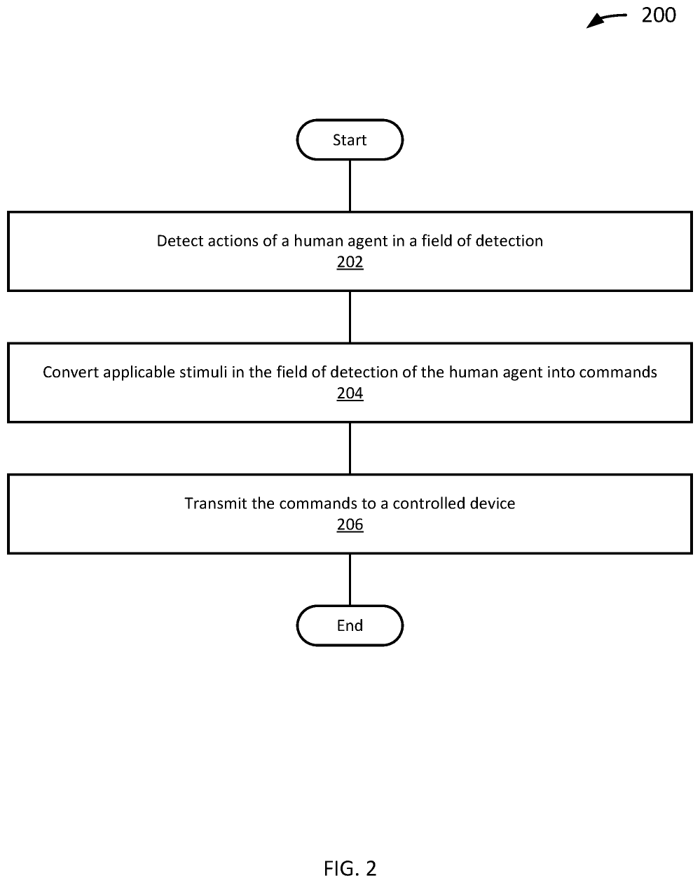

FIG. 2 depicts a flowchart 200 of an example of a method for controlling a device using gestures. The flowchart 200 begins at module 202 where actions of a human agent are detected in a field of detection. A human-to-machine interface-assisting sensor suite, such as the human-to-machine interface-assisting sensor suite 104, is an example of a device capable of detecting actions of a human agent in a field of detection.

The flowchart 200 continues to module 204 where applicable stimuli in the field of detection of the human agent are converted into commands. A gesture interpretation engine, such as the gesture interpretation engine 106, is an example of an engine capable converting applicable stimuli in a field of detection of a human agent into commands.

The flowchart 200 continues to module 206 where commands are transmitted to a controlled device. A machine control engine, such as the machine control engine 108, is an example of an engine capable transmitting commands to a controlled device.

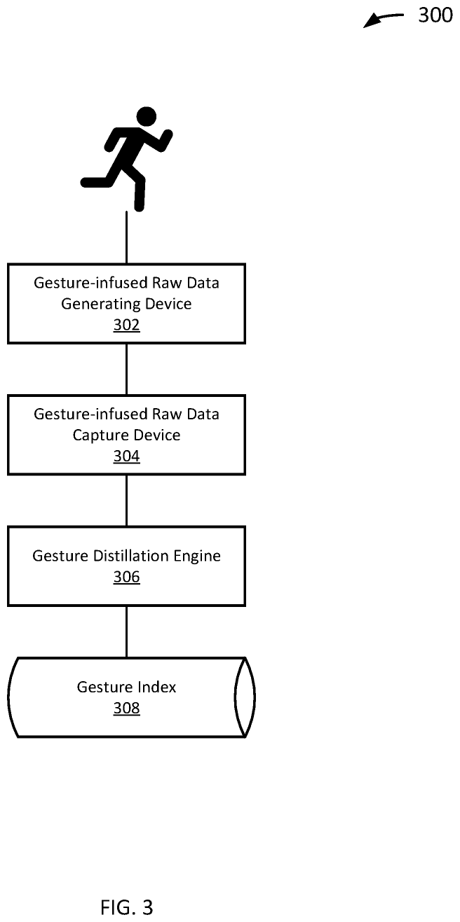

FIG. 3 depicts a diagram 300 of an example of a gesture-infused raw data capture and analysis system. The diagram 300 includes a gesture-infused raw data generating device 302, a gesture-infused raw data capture device 304 coupled to the gesture-infused raw data generating device 302, a gesture distillation engine 306 coupled to the gesture-infused raw data capture device 304, and a gesture index datastore 308 coupled to the gesture distillation engine 306.

The gesture-infused raw data generating device 302 is intended to represent a device that includes an inertial measurement device (e.g., accelerometer, gyroscope, and/or other sensors), a video capture device, or some other sensor capable of detecting position and/or movement of a target. In a specific implementation, the gesture-infused raw data generating device 302 includes a smart band with sensors for detecting movement- or position-related stimuli of a target person. Instead or in addition, the gesture-infused raw data generating device 302 is an optical sensor, such as is found in a GoPro® camera, that is used to record people doing various things, such as climbing a ladder, running, clapping hands, etc. Advantageously, the approach of using a camera in a studio or other controlled environment to establish a baseline collection of gesture-infused raw data can later be augmented with a smart band-wearing person in the field or in an uncontrolled or natural environment.

In a specific implementation, a smart band in the field is used to detect stimuli gestures for command and control purposes. For example, the gesture-infused raw data generating device 302 can operate in a “recording mode” in tandem with a “gesture-detection mode.” Alternatively or in addition, easy-to-detect gestures can be used to switch a smart band in the field from “gesture-detection mode” to “recording mode,” and vice versa. Recording mode is intended to represent a mode that generates data for a machine learning algorithm tasked to differentiate between gestures and other bodily movements. What constitutes a gesture is defined as a movement that corresponds to a command. In a specific implementation, gestures are predefined. Alternatively or in addition, one or more gestures can be defined after data has been received, potentially with some human or artificial agent curation (e.g., a video feed could be used in conjunction with time-synchronous captured data to introduce a new gesture that had not been defined previously).

The gesture-infused raw data capture device 304 is intended to represent a non-transitory storage medium and engines used to capture and, potentially, preprocess (e.g., categorize) raw data. The gesture-infused raw data capture device 304 can be distributed in the sense that a smart band may include a relatively small amount of memory but be coupled to a larger memory, which together can be considered to comprise the non-transitory storage medium. In a specific implementation, the gesture-infused raw data capture device 304 tags or otherwise indicates that a first portion of the gesture-infused raw data is a gesture, and indicates, either explicitly as a “not gesture” or by virtue of it not being tagged as a gesture, that a second portion of the gesture-infused raw data is not a gesture (and/or explicitly identify the nature of the second portion). Gesture-infused raw data that has been tagged in this manner can be referred to as gesture-tagged raw data, but gesture-infused raw data is used in this paper to encompass both untagged and tagged raw data. In any case, gesture-infused raw data can be added to training data, which can be augmented with new gesture-infused raw data generated at a studio or in the field.

In a specific implementation, the gesture-infused raw data generating device 302 and the gesture-infused raw data capture device 304 are included in separate discrete devices. For example, the gesture-infused raw data generating device 302 can include a smart band and the gesture-infused raw data capture device 304 can include a camera (e.g., a GoPro® camera), both of which are used to record human agents doing things (e.g., climbing ladders, running, clapping hands, etc.) and making gestures. Advantageously, the capture of the motions and gestures can be done in a controlled environment, such as in a studio, and combined with motions and gestures captured outside of the controlled environment, if desired.

In a specific implementation, a discrete device includes both the gesture-infused raw data generating device 302 and the gesture-infused raw data capture device 304. For example, a smartphone or camera can be characterized as including both the gesture-infused raw data generating device 302 and the gesture-infused raw data capture device 304. In such an implementation, the gesture-infused raw data generating device 302 and the gesture-infused raw data capture device 304 can be characterized, in the aggregate, as including an image sensor. An image sensor converts an optical image to an electronic signal, which is then sent to non-volatile storage, such as a memory card. There are two main types of image sensors that are used in most digital cameras: CMOS and CCD.

The gesture distillation engine 306 is intended to represent a training engine to take data representing people in motion, as captured by the gesture-infused raw data capture device 304, and derive a minimalistic gesture index. Gesture-infused raw data can be used to duplicate behavior for thousands of movements as a complete graphic. However, a complete graphic takes up a great deal of space and requires a great deal of processing to match to detected movement and position, and therefore, in a specific implementation, wearables are provided with indices from training. The gesture distillation engine 306 removes movement and other environmental noise, if applicable, leaving only one or more gestures, which take up a relatively small space and enable efficient processing to match a gesture index to detected movement. As such, the output of the gesture distillation engine 306 can be characterized as including a gesture index or a minimalistic gesture index. It should be understood that the gesture distillation engine 306 evaluates a whole gesture to provide a command (e.g., moving a hand between vertical and horizontal to control volume; twisting a wrist twice to take a picture, change a track, or dismiss an incoming call; or sweeping a hand back to change a slide), but the minimalistic gesture index, by virtue of being small will necessarily discard some of the data associated with the whole gesture.

In a specific implementation, the gesture distillation engine 306 includes a preprocessing engine; it may be desirable to preprocess at a wearable device (or at an intermediate location at a smartphone, in the cloud, etc.) to save resources that would otherwise be required for the transmission of raw data. More generally, gesture distillation can involve multiple engines, some of which are used even prior to receiving raw data from, e.g., the gesture-infused raw data capture device 304. For example, a gesture pattern definition engine may be used to define a gesture and a gesture capturing data extraction engine can be configured as appropriate prior to receiving raw (or preprocessed) data. Gesture distillation also involves multiple engines used after receiving data, such as a training data output engine, a neural network (a useful machine learning tool in this instance because it facilitates accurate gesture detection with a small footprint), and a neural network coefficients translation engine (which translates to an architecture developed for processors). Optionally, gesture distillation can involve one or more engines on a wearable device as well.

Knowledge of characteristics of a field of detection (e.g., the location of a human agent whose gestures are to be captured) or additional sensors (e.g., a camera) can potentially improve gesture distillation accuracy and efficiency. For example, a person in a car is somewhat movement constrained, which is knowledge that may facilitate improved feature extraction; knowledge of a floorplan can aid in identifying interactions with the environment, such as pointing at a light in an effort to dim/brighten or turn it on/off; or detecting a beacon can help determine where a field of detection is located with respect to the beacon. As another example, time-synchronized video can enable improved gesture identification (e.g., start and stop times of a gesture); a heartrate and/or blood pressure monitor could be used to detect an exercise or emergency, and switch to an environmental awareness that is more conducive to detecting gestures relevant in an exercise or emergency (including a likely “wave off” gesture in an emergency context to ensure alerts are not generated prematurely); or an explicit button or switch that forces the system to enter into a specific mode (e.g. a panic button).

Due to the relative complexity of training new gestures with few false negatives and, even more importantly, few false positives, it may be desirable to rank “easy to detect” gestures as better candidates for certain commands. For example, an easy-to-detect gesture could be used to open a command console to capture new data. In some instances, gestures must be customizable. For example, “sign in the air” can be used to authenticate or even sign a document, but the signature is unique to an individual, who must train the system to recognize the signature. In a jurisdiction that recognizes “sign in the air” as a legal signature, this process could even be used to purchase goods and services.

The gesture index datastore 308 is intended to represent a datastore in which gesture indices are stored. A gesture index includes a gesture pattern. In a specific implementation, the gesture indices include a minimalistic gesture index with a minimalistic gesture pattern. It may be noted it may not be necessary to actually understand how position varies over time; one can rely upon statistics metrics that change over time. A neural net with 16 inputs, 22 neurons, and 4 outputs has been found to provide a footprint suitable for a wearable device. Inner layers can be changed with different hardware; for example a microcontroller with 1 KB memory might have 2 or 3 neurons, while a microcontroller with 1 MB will have more. For general purpose use, the number of neurons could be increased, but is unlikely to exceed 50 neurons. Principle component analysis can be used, but it requires a lot of memory and may have poorer performance. Wavelet domain (see also Fourier transforms, which are good with stable signals) may also be problematic due to memory and space constraints.

Advantageously, the gesture index datastore 308 could be packaged (potentially along with a machine learning algorithm) and sold to third parties. For example, a wearable device manufacturer could purchase a gesture detection package from a dedicated gesture distillation company.

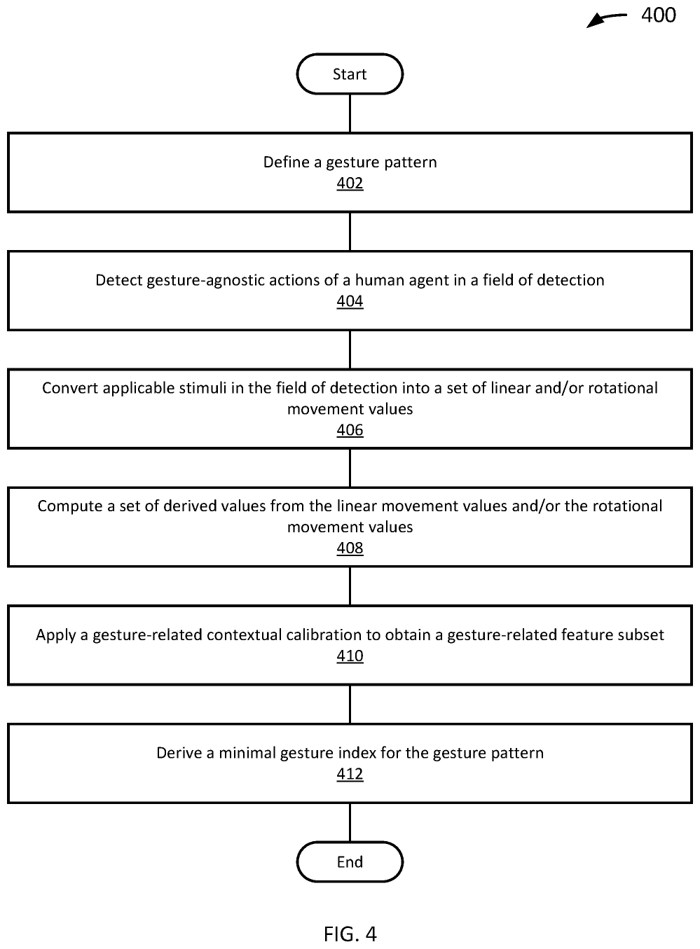

FIG. 4 depicts a flowchart 400 of an example of a method for obtaining a minimal gesture index. The flowchart 400 starts at module 402 where a gesture pattern is defined. In a specific implementation, a gesture pattern is defined to include 96 features: 6 channels of sensors (x,y,z linear movement for an accelerometer and x,y,z rotational movement for a gyroscope, plus video, if applicable) times 16 samples for buffer. Derived values can include mode value, mean frequency between samples, mean value, standard deviation, or the like. The sample is a position over time (e.g., at 119 Hz). It may be desirable to include preprocessing (not illustrated) that entails designing how to capture a gesture; preprocessing involves data extraction from raw data.

The flowchart 400 continues to module 404 with detecting gesture-agnostic actions of a human agent in a field of detection. The actions are considered gesture-agnostic because the detected actions intentionally include both activities that do not include gestures (e.g., climbing, running, walking, etc.) and activities that include gestures, but sensor values are recorded for all activities in the field of detection. It is theoretically possible to use something other than a human agent in the field of detection, but in a specific implementation, a human agent is preferable. The field of detection can be defined as the stimuli that can be detected by the applicable sensors.

The flowchart 400 continues to module 406 with converting applicable stimuli in the field of detection into a set of linear and/or rotational movement values. Applicable stimuli are stimuli that are detectable by a given sensor. For example, a typical accelerometer is capable of detecting stimuli associated with proper acceleration of a target object in the field of detection. (For the avoidance of doubt, acceleration, such as would be measured by an accelerometer, in a linear direction is considered a “linear movement value” in this paper.) Sensors capable of measuring linear movement typically employ resistive, capacitive, inductive, magnetic, time-of-flight, or pulse encoding technology. A gyroscope is a device for measuring or maintaining orientation or angular velocity. A gyroscope can be implemented as a spinning disc in which the axis of rotation is free to assume any orientation, but other operating principles can be used, such as in MEMS gyroscopes (popular in smartphones), solid state ring lasers, and fiberoptic gyroscopes, to name a few.

To the extent a sensor is remote relative to a gesture distillation engine, the sensor can be coupled to a radio transmitter that sends sensor values over the air. In an implementation in which the sensor is operating in a controlled environment, the sensor values may or may not be transmitted in the clear. In an implementation in which the sensor is operating outside of a controlled environment, it may be desirable to encrypt the sensor values when they are sent over the air.

The flowchart 400 continues to module 408 with computing a set of derived values from the linear movement values and/or the rotational movement values. Derived values can include mode value, mean frequency between samples, mean value, standard deviation, or the like. Because it is a goal to find a relatively small subset of features indicative of a specific gesture, it has been found that certain derived values are more useful than sequences of raw motion-related values, though one or more raw motion-related values could be useful as well.

The flowchart 400 continues to module 410 with applying a gesture-related contextual calibration to obtain a gesture-related feature subset. A gesture-related contextual calibration includes tagging to indicate a gesture start time, a gesture end time, a non-gesture start time, a non-gesture end time, or some combination of these. A gesture-related feature subset is a subset of features that can be fed into a machine learning algorithm to determine whether it is an advantageous feature subset from the perspective of gesture identification.

In a specific implementation, a feature subset is shared with a training computer in plain text because it is convenient for natural values. The plain text may be sent in the clear (unencrypted) because it is sent internally; coefficients may be encrypted when not internal (or when there is otherwise increased risk). Raw data can be sent to a smartphone (e.g., from a smart band), sent over a WLAN, and/or sent to the cloud, making it potentially desirable to encrypt data, as well, because tampering with coefficients can interfere with provisioning. Depending upon various factors, raw data may be discarded or treated differently depending upon tiers of service. For example, raw data may be kept if captured in association with a public tier, kept with consent if captured in association with an individualized tier, or discarded if captured in association with a private tier. Developers will generally desire raw data to enable them to make decisions with the data, but this is not required. For example, game developers can control with a smart band and can send raw data to a separate entity for training purposes (and a gamer need not modify a wearable at all, though the game system can detect readings).

The flowchart 400 ends at module 412 where a minimal gesture index for the gesture pattern is derived. In a specific implementation, a neural network is used to derive the minimal gesture index. It may be desirable to derive a gesture index with as small a footprint as is needed to fit on a target device; this footprint is referred to in this paper as a minimal gesture index. The minimal gesture index can be installed on a wearable device.

In an example of operation, a device, such as a wearable device, generates a token and then encrypts and sends gesture-infused raw (or preprocessed) data to a server using the token as an identifier. The server decrypts the data, generates coefficients, encrypts the coefficients, and sends the coefficients back to the device. In a specific implementation, coefficients for a neural network are translated to an architecture developed for a given set of processors. If desired for security or to reduce storage requirements, the raw data can be discarded. In a specific implementation, the coefficients are stored on the server, where a file is generated for multiple devices all capable of decrypting the coefficients when sent, and shared in a “public” modality. Instead or in addition, only the unique owner of the token can get the coefficients in a “private” modality.

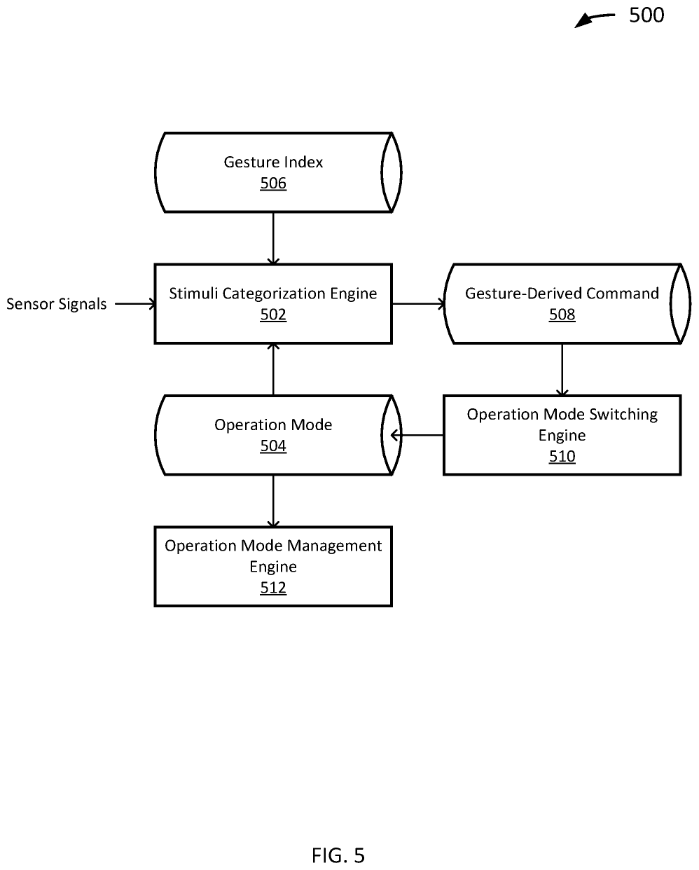

FIG. 5 depicts a diagram 500 of an example of a selective operation mode management system. The diagram 500 includes a stimuli categorization engine 502, an operation mode datastore 504, a gesture index datastore 506, a gesture-derived command datastore 508, an operation mode switching engine 510, and an operation mode management engine 512. The stimuli categorization engine 502 is intended to represent an engine that functions to determine stimuli associated with gestures made by a human agent in a field of detection and convert them to one of a set of commands available to the human agent in a current mode of operation. In determining stimuli associated with gestures, the stimuli categorization engine 502 can gather data from an applicable component, mechanism, or sensor integrated as part of a wearable device. The stimuli categorization engine 502 may or may not also be able to determine “not a command gesture” stimuli from data gathered from applicable mechanisms, components, or sensors integrated with or as part of a wearable device. For example, the stimuli categorization engine 502 can determine a movement (including, potentially, what could colloquially be characterized as a “gesture”) by a human agent in a field of detection is not a gesture that is associated with a command in a given operation mode. As another example, the stimuli categorization engine 502 can determine a temperature based on data generated by a thermometer at a wearable device, a nearby transmitter coupled to a thermometer, or the like, is not a command gesture or, indeed, is not derived from a movement of a human agent at all.

The operation mode datastore 504 is intended to represent a datastore that functions to store operation mode data for use by the stimuli categorization engine 502 in determining a stimuli is a relevant gesture. In a specific implementation, a first operation mode has gesture parameters different than those of a second operation mode, as opposed to simply treating the same gestures differently depending upon the mode. For example, a first operation mode could listen for a “volume change” gesture in a mode associated with listening to audio on a smartphone or dedicated audio device and a second mode, which is entered when the “volume change” gesture is detected, could listen for a “volume up” or a “volume down” gesture that would not be treated as a gesture when in the first operation mode.

The gesture index datastore 506 is intended to represent a datastore that functions to store a gesture index applicable to one or more operation modes for use by the stimuli categorization engine 502 in determining a stimuli is a relevant gesture when in at least one of the one or more operation modes. In a specific implementation, the gesture index includes a single gesture index for switching between operation modes. As the number of operation modes available to a wearer increases, it becomes more important to have a gesture for changing to a “listen for mode switching” operation mode during which gestures can be used to switch between multiple operation modes. Some operation modes may be inaccessible from a current operation mode, making it necessary to cycle between modes to reach a desired mode, but with the advantage of reducing processing and data storage requirements by reducing the number of gestures that must be detected. For example, a single gesture could be used to switch from a first mode to a second mode, from the second mode to a third mode, and from the third mode back to the first mode. Operation mode data stored in the operation mode datastore 504 can include operational parameters of different operation modes of a wearable device.

The gesture-derived command datastore 508 is intended to represent a datastore of a command associated with a gesture of a human agent in a field of detection that matches a gesture index in the gesture index datastore 506. In a specific implementation, the gesture-derived command datastore 508 includes a command bus onto which the command is provided. The command is applicable to a given operation mode, but in some embodiments, the gesture-derived command datastore 508 includes gesture-agnostic commands; in such embodiments, once a command is derived from a gesture, the command may or may not be indistinguishable from commands that are not derived from gestures.

The operation mode switching engine 510 is intended to represent an engine that upon detecting an operation mode switching command in the gesture-derived command datastore 508 switches between operation modes that impact how a wearable device operates or how data transmitted from a wearable device is interpreted. For example, operation mode can specify when a wearable device is operating in a low power mode, in which case environmental sensors used to measure characteristics of an environment are powered down. As another example, operation mode can specify a recording mode during which sensors capture raw data for preprocessing and transmission to a training engine. As another example, the operation mode switching engine 510 can set an operation mode based on input received from a parent of a child who will wear or who is currently wearing a wearable device, such as a power down mode, an alert mode (to indicate it is time to come home or take medicine), or the like.

In a specific implementation, an operation mode switching command is one of a plurality of gesture-derived commands. Engines configured to respond to other commands are not shown, such as a volume control engine, but are assumed.

The operation mode management engine 512 is intended to represent an engine that controls operation of a wearable device according to a specific operation mode. For example, the operation mode management engine 512 can control mechanisms, sensors, and other components of a wearable device to operate according to a low power operation mode when in the low power operation mode. In a specific implementation, the operation mode management engine 512 functions to control operation of a wearable device using operation mode data from the operation mode datastore 504.

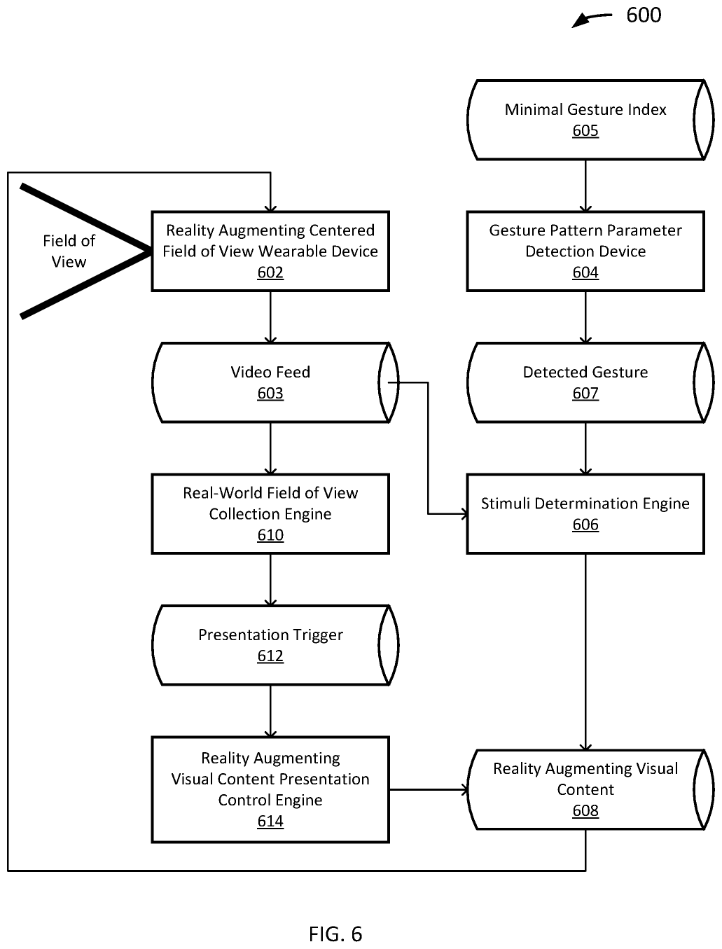

FIG. 6 depicts a diagram 600 of an example of a reality augmenting visual content presentation management system. The diagram 600 includes a reality augmenting centered field of view wearable device 602, a video feed datastore 603, a gesture pattern parameter detection device 604, a minimal gesture index datastore 605, a stimuli determination engine 606, a detected gesture datastore 607, a reality augmenting visual content datastore 608, a real-world field of view collection engine 610, a presentation trigger datastore 612, and a reality augmenting visual content presentation control engine 614. The reality augmenting visual content presentation management system can be implemented, at least in part, at one or a combination of the reality augmenting centered field of view wearable device 602, a client device of a human agent utilizing the reality augmenting centered field of view wearable device 602, or a location remote from the reality augmenting centered field of view wearable device 602. For example, the reality augmenting visual content presentation management system can be implemented, at least in part, in the cloud.

The reality augmenting centered field of view wearable device 602 is intended to represent a device with a video display that a human agent utilizing the reality augmenting centered field of view wearable device 602 can see. In a specific implementation, the reality augmenting centered field of view wearable device 602 includes a camera, a combiner (which combines glass lenses that allow natural light to pass through to the eyes of a human agent with digital LED or OLED displays that send a computer-generated image to the eyes), a registration (which comprises augmented reality (AR) objects), and a computer vision suite (which combines the computer-generated images and camera feed). In a specific implementation, the reality augmenting centered field of view wearable device 602 includes AR goggles. Instead or in addition, the reality augmenting centered field of view wearable device 602 can include a smartphone.

The video feed datastore 603 is intended to represent a datastore that includes sensor data from the reality augmenting centered field of view wearable device 602, which in the example of FIG. 6 assumes at least a camera capable of generating a video feed.

The gesture pattern parameter detection device 604 is intended to represent a device with sensors capable of detecting stimuli associated with movement of a human agent. The human agent may or may not be the same human agent that utilizes the reality augmenting centered field of view wearable device 602, though in a specific implementation they are the same human agent. In a specific implementation, the gesture pattern parameter detection device 604 includes a smart band. Instead or in addition, the gesture pattern parameter detection device 604 can include a smartphone.

The minimal gesture index datastore 605 is intended to represent a small form factor datastore suitable for use on a wearable device with limited storage and processing capabilities, such as the minimal gesture indices discussed previously in this paper. In a specific implementation, the gesture pattern parameter detection device 604 and the minimal gesture index datastore 605 are included in a discrete wearable device.

The stimuli determination engine 606 is intended to represent an engine that functions to determine stimuli associated with operation of the reality augmenting centered field of view wearable device 602 and the gesture pattern parameter detection device 604. In a specific implementation, the stimuli determination engine 606 directly or indirectly obtains data from an applicable component, mechanism, or sensor integrated as part of the reality augmenting centered field of view wearable device 602 and/or the gesture pattern parameter detection device 604 that detects stimuli in accordance with the technological capabilities of the component, mechanism, or sensor. For example, the stimuli determination engine 606 can obtain data from an accelerometer that detects linear movement (i.e., stimuli the accelerometer is able to detect) and a gyroscope that detects rotational movement, both of which are associated with movement of the reality augmenting centered field of view wearable device 602 and/or the gesture pattern parameter detection device 604.

In a specific implementation, the stimuli determination engine 606 processes a captured feed of a real-world field of view of a human agent utilizing the reality augmenting centered field of view wearable device 602 to determine stimuli associated with operation of the device. In performing processing on a captured feed of a real-world field of view of a human agent, the stimuli determination engine 606 is configured to recognize objects in the captured feed of the real-world field of view of the human agent. For example, the stimuli determination engine 606 can apply an applicable method of object recognition to recognize objects in a captured feed of a real-world field of view of a human agent. The stimuli determination engine 606 can perform edge processing on a captured feed of a real-world field of view of a human agent to recognize objects in the captured feed.

In a specific implementation, the stimuli determination engine 606 converts an identification of a gesture, as stored in the detected gesture datastore 607, into a command. In an alternative, the stimuli determination engine 606 processes sensor values from the gesture pattern parameter detection device 604 to determine whether given stimuli (e.g., a set of sensor values) corresponds to a gesture. Advantageously, the determination that given stimuli corresponds to a gesture can be augmented by stimuli obtained from a camera of the reality augmenting centered field of view wearable device 602 to improve precision (e.g., if a certain gesture has potentially unintentional head movements), improve the richness of the data (e.g., if a gesture includes pointing and the camera can capture a real-world or AR object to which a human agent is pointing), or to auto-select an appropriate operational mode (e.g., if a human agent is looking at an AR object as opposed to a real-world object, the operational mode may be different).

An operational environment of the reality augmenting centered field of view wearable device 602 need not be determined exclusively via the field of view camera. For example, the stimuli determination engine 606 could be configured to determine a position of the reality augmenting centered field of view wearable device 602 from data gathered from a GPS receiver integrated as part of the reality augmenting centered field of view wearable device 602 and/or the gesture pattern parameter detection device 604.

The reality augmenting visual content datastore 608 is intended to represent an applicable datastore for storing reality augmenting visual content data. Reality augmenting visual content data stored in the reality augmenting visual content datastore 608 can include data used in presenting reality augmenting visual content to a user of a reality augmenting centered field of view wearable device. For example, reality augmenting visual content data stored in the reality augmenting visual content datastore 608 can include a PDF file of a document used in presenting the document as a virtualized document as part of reality augmenting visual content to a user through a reality augmenting centered field of view wearable device. In general, reality augmenting visual content can be referred to as AR objects (and metadata, if applicable).

The real-world field of view collection engine 610 is intended to represent an engine that functions to collect data indicating a captured real-world field of view of a human agent utilizing the reality augmenting centered field of view wearable device 602. The real-world field of view collection engine 610 can collect data indicating a captured field of view from an applicable mechanism for capturing a real-world field of view of a human agent utilizing the reality augmenting centered field of view wearable device 602. For example, the real-world field of view collection engine 610 can collect a captured feed of a real-world field of view of a human agent generated by an outward facing camera integrated as part of the reality augmenting centered field of view wearable device 602.

The presentation trigger datastore 612 is intended to represent a datastore that functions to store presentation triggers in data structures. Presentation triggers are activated when a triggering threshold is met. Activated presentation triggers cause the reality augmenting centered field of view wearable device 602 to present specific reality augmenting visual content to a human agent utilizing the reality augmenting centered field of view wearable device 602. In a specific implementation, the presentation trigger datastore 612 includes an identification of specific reality augmenting visual content to present when a presentation trigger associated with the specific reality augmenting visual content is activated.

In a specific implementation, presentation trigger data stored in the presentation triggers datastore 612 specifies how to modify or augment captured content. Presentation triggers data stored in the presentation triggers datastore 612 can specify how to modify or augment a captured real-world field of view of a human agent utilizing the reality augmenting centered field of view wearable device 602. For example, presentation triggers data stored in the presentation triggers datastore 612 can specify augmenting body parts of a human agent captured in a real-world field of view of the human agent captured at the reality augmenting centered field of view wearable device 602 when presenting the captured real-world field of view of the human agent. As a more specific variant of the example, presentation triggers data stored in the presentation trigger datastore 612 can specify replacing hands of a human agent in a captured real-world field of view of the human agent with translucent representations of the hands of the human agent.

The reality augmenting visual content presentation control engine 614 is intended to represent an engine that manages presentation of reality augmenting visual content through the reality augmenting centered field of view wearable device 602. The reality augmenting visual content presentation management control engine 614 can control presentation of reality augmenting visual content centered in a field of view of a user through the reality augmenting centered field of view wearable device 602. For example, the reality augmenting visual content presentation control engine 614 can control presentation of virtualized documents in a captured feed of a real-world field of view of a user of the reality augmenting centered field of view wearable device 602. In another example, the reality augmenting visual content presentation control engine 614 can augment body parts of a human agent utilizing the reality augmenting centered field of view wearable device 602 in a captured feed of a real-world field of view of the human agent, as part of presenting reality augmenting visual content to the human agent through the reality augmenting centered field of view wearable device 602.

In a specific implementation, the reality augmenting visual content presentation control engine 614 displays content in accordance with commands derived from gestures made by a human agent through sensors of the gesture pattern parameter detection device 604. For example, the reality augmenting visual content presentation control engine 614 can determine virtualized documents to superimpose on a real-world field of view of a human agent when the user points (gestures) towards an AR object associated with the documents. In presenting reality augmenting visual content to a human through the reality augmenting centered field of view wearable device 602, the reality augmenting visual content presentation control engine 614 can cause a display integrated as part of the reality augmenting centered field of view wearable device 602 to display reality augmenting visual content to the human agent.

In a specific implementation, the reality augmenting visual content presentation control engine 614 functions to present reality augmenting visual content as part of a presentation of a captured real-world field of view of a human agent through the reality augmenting centered field of view wearable device 602. In presenting reality augmenting visual content as part of a presentation of a captured real-world field of view of a human agent, the reality augmenting visual content presentation control engine 614 can augment the presentation of a captured real-world field of view of the human agent. For example, the reality augmenting visual content presentation control engine 614 can superimpose a volume control readout while a human agent is in volume control mode and is gesturing to increase or decrease volume. In another example, the reality augmenting visual content presentation control engine 614 can make captured body parts in the field of view translucent.

In a specific implementation, the reality augmenting visual content presentation control engine 614 functions to control presentation of reality augmenting visual content based on determined stimuli associated with operation of the reality augmenting centered field of view wearable device 602 and/or the gesture pattern parameter detection device 604. For example, if stimuli associated with operation of the reality augmenting centered field of view wearable device 602 and/or the gesture pattern parameter detection device 604 indicate a human agent is distressed, then the reality augmenting visual content presentation control engine 614 can present a distress beacon for selection by the human agent, as part of reality augmenting visual content.

In a specific implementation, the reality augmenting visual content presentation control engine 614 functions to control presentation of reality augmenting visual content according to presentation triggers. In controlling presentation of reality augmenting visual content according to presentation triggers, the reality augmenting visual content presentation control engine 614 can determine if presentation triggers associated with specific reality augmenting visual content are met in order to determine whether to present the specific reality augmenting visual content.

Advantageously, the combination of an augmented reality system with a wearable that includes a minimal gesture index results in a light-weight collection of devices with high gesture-detecting accuracy and relatively low processor requirements.

1. A method for obtaining a minimal gesture index, the method comprising:
defining a gesture pattern;
detecting gesture-agnostic actions of a human agent in a field of detection, the gesture agnostic actions including actions that include gestures and actions that do not include gestures;
converting applicable stimuli in the field of detection into a set comprising one or more of linear movement values and rotational movement values;
computing a set of derived values from the one or more of linear movement values and rotational movement values;
applying a gesture-related contextual calibration to obtain a gesture-related feature subset;
deriving a minimal gesture index for the gesture pattern.

2. The method of claim 1, further comprising determining a size of the minimal gesture index based on an amount of storage on a wearable device on which the minimal gesture index is to be stored.

3. The method of claim 1, wherein the detecting the gesture-agnostic actions of the human agent is performed by one or more of an accelerometer, a gyroscope, and a camera.

4. The method of claim 1, wherein the detecting the gesture-agnostic actions is performed at least by an accelerometer, the accelerometer using resistive, capacitive, inductive, magnetic, time-of-flight, or post encoding technology.

5. The method of claim 1, wherein the detecting the gesture-agnostic actions is performed at least by a gyroscope, the gyroscope comprising a MEMS gyroscope, a fiberoptic gyroscope, a solid state ring laser, or a spinning disc in which an axis of rotation is capable of assuming any orientation.

6. The method of claim 1, wherein the derived values include one or more of mode value, mean frequency between samples, mean value, and standard deviation.

7. The method of claim 1, wherein the applying the gesture-related contextual calibration to obtain the gesture-related feature subset includes tagging to indicate one or more of a gesture start time, a gesture end time, a non-gesture start time, and a non-gesture end time.

8. The method of claim 1, further comprising sharing the gesture-related feature subset with a training computer in encrypted plain text or in non-encrypted plain text.

9. The method of claim 1, wherein the minimal gesture index is derived using a neural network.

10. The method of claim 9, further comprising translating coefficients for the neural network to an architecture developed for a particular set of processors.

11. The method of claim 1, further comprising:
generating, by a wearable device, a token;
sending, by the wearable device, one or more of gesture-infused raw data and gesture-infused preprocessed data to a server using the token as an identifier;
wherein the server:
decrypts the one or more of gesture-infused raw data and gesture-infused preprocessed data;
generates and encrypts coefficients;
sends the coefficients to the wearable device.

12. The method of claim 11, wherein the data is at least gesture-infused raw data, the method further comprising discarding the gesture-infused raw data.

13. The method of claim 11, further comprising:
storing the coefficients on the server;
generating a file for multiple devices, the multiple devices being capable of decrypting the coefficients;
sharing the file in a public modality.

14. A system comprising:
a gesture pattern definition engine configured to define a gesture pattern;
a human-to-machine interface-assisting sensor suite configured to detect gesture-agnostic actions of a human agent in a field of detection, the gesture agnostic actions including actions that include gestures and actions that do not include gestures;
a gesture interpretation engine configured to:
convert applicable stimuli in the field of detection into a set comprising one or more of linear movement values and rotational movement values;
compute a set of derived values from the one or more of linear movement values and rotational movement values;
apply a gesture-related contextual calibration to obtain a gesture-related feature sub set;
a gesture distillation engine configured to derive a minimal gesture index for the gesture pattern.

15. The system of claim 14, wherein the gesture distillation engine is further configured to determine a size of the minimal gesture index based on an amount of storage on a wearable device on which the minimal gesture index is to be stored.

16. The system of claim 14, wherein the human-to-machine interface-assisting sensor suite comprises one or more of an accelerometer, a gyroscope, and a camera.

17. The system of claim 14, wherein the derived values include one or more of mode value, mean frequency between samples, mean value, and standard deviation.

18. The system of claim 14, wherein the applying the gesture-related contextual calibration to obtain the gesture-related feature subset includes tagging to indicate one or more of a gesture start time, a gesture end time, a non-gesture start time, and a non-gesture end time.

19. The system of claim 14, wherein the gesture distillation engine is configured to derive the minimal gesture index using a neural network.

20. The system of claim 19, wherein the gesture distillation engine is further configured to translate coefficients for the neural network to an architecture developed for a particular set of processors.

21. The system of claim 14, further comprising:
a wearable device configured to:
generate a token;
send one or more of gesture-infused raw data and gesture-infused preprocessed data to a server using the token as an identifier;
the server configured to:
decrypt the one or more of gesture-infused raw data and gesture-infused preprocessed data;
generate and encrypt coefficients;
send the coefficients to the wearable device.
